(19) United States
(12) Patent Application Publication
(10) Pub. No.: US 2020/0232270 A1
(43) Pub. Date: Jul. 23, 2020

(54) CHILD SAFETY DOOR

(71) Applicant: Albert Jernigan, Rincon, GA (US)

(72) Inventor: Albert Jernigan, Rincon, GA (US)

(21) Appl. No.: 16/255,385

(22) Filed: Jan. 23, 2019

(51) Int. Cl. E06B 5/10; E05B 65/06; E06B 9/01

(52) U.S. Cl. CPC E06B 5/10; E05B 65/06; E06B 2009/002; E06B 2009/015; E06B 9/01

(57) ABSTRACT

Child safety doors described herein can keep babies, toddlers, and children of other ages from accessing areas of a house or other building. In one aspect, a child safety door includes a door with a first side and a second side opposite the first side. The door has a height of at least sixty inches and a width of at least twenty-four inches. The door has an opening that extends through the door from the first side to the second side. The opening is located at a top half of the door when the door. The opening has spindles that each extend from a bottom of the opening to a top of the opening. The door has a locking mechanism that, when locked, prevents a person from opening the door from either side of the door without placing the locking mechanism in an unlocked position.

### BACKGROUND

Child safety gates (e.g., baby gates) are designed to keep babies, toddlers, and other children from accessing areas of a home or other building. For example, many child safety gates are designed to be placed in doorways to keep children from entering or leaving a room, stairway, or other area.

### SUMMARY

This specification describes child safety doors that more safely prevent children from accessing areas of a building.

Child safety gates result in many injuries to children each year. Many of these injuries are either the result of a child climbing over the gate and falling or getting injured in a room that the baby gate was supposed to prevent the child from entering. Additional injuries occur when children remove the baby gate, e.g., by pushing the gate over due to the gate not being snuggly fit between a door. Child safety doors described herein are safer than child safety gates as children cannot climb over or open the child safety doors, while still providing an open air feature that allows for a parent or other caregiver to be able to see and/or hear a child that is on the other side of the child safety door.

In general, one innovative aspect of the subject matter described in this specification can be embodied in a child safety door that includes a door with a first side and a second side opposite the first side. The door can have a height of at least sixty inches and a width of at least twenty-four inches. The door can also have an opening that extends through the door from the first side to the second side. The opening can be located at a top half of the door when the door is installed in a doorway. The opening can have a height of at least ten inches and a width of at least ten inches. The opening can also have spindles that each extend from a bottom of the opening to a top of the opening. The door can also have a locking mechanism that, when locked, prevents a person from opening the door from either side of the door without placing the locking mechanism in an unlocked position.

These and other embodiments can each optionally include one or more of the following features. In some aspects, the door has a height between seventy-eight and eighty-two inches and a width between twenty-two and thirty-eight inches. The opening can have a height between twenty and twenty-four inches and a width between twenty and twenty-four inches. The bottom of the opening can be between thirty and fifty inches above a bottom of the door.

In some aspects, each spindle is spaced apart from each adjacent spindle by no more than four inches. In some aspects, the locking mechanism can include a double-keyed lock. The double-keyed lock can include a double-keyed deadbolt.

In general, another innovative aspect of the subject matter described in this specification can be embodied in a method for using a child safety door to protect a child. The method can include providing a child safety door in a doorway. The child safety door can include a door with a first side and a second side opposite the first side. The door can have a height between seventy-eight and eighty-two inches and a width between twenty-two and thirty-eight inches. The door can also include an opening that extends through the door from the first side to the second side. The opening can be located such that a bottom of the opening is at least thirty-six inches above a bottom of the door. The aperture can have a height of at least twenty inches and a width of at least twenty inches. The door can also include spindles that each extend from the bottom of the aperture to a top of the aperture. The door can also include a locking mechanism that, when locked, prevents a person from opening the door from either side of the door without a key. The child safety door can be closed such that the child safety door blocks children from going through the doorway. The locking mechanism of the child safety door can be locked while the child safety door is closed.

These and other embodiments can each optionally include one or more of the following features. In some aspects, providing the child safety door can include installing the child safety door in the doorway. In some aspects, the opening can have a height between twenty and twenty-four inches and a width between twenty and twenty-four inches.

In some aspects, the bottom of the opening is between thirty and fifty inches above a bottom of the door. In some aspects, each spindle is spaced apart from each adjacent spindle by no more than four inches. The locking mechanism can include a double-keyed lock.

In general, another innovative aspect of the subject matter described in this specification can be embodied in a method of forming a child safety door. The method can include creating, within a door having a first side and a second side opposite the first side, an aperture that extends through the door from the first side to the second side. The aperture can be created in a top half of the door. The aperture can have a height of at least ten inches and a width of at least ten inches. A spindles can be installed in the aperture. Each spindle can extend between a bottom of the aperture and a top of the aperture. A locking mechanism can be installed. The locking mechanism can prevent the door from being opened from either side of the door without placing the locking mechanism in an unlocked position.

These and other embodiments can each optionally include one or more of the following features. In some aspects, installing the spindles within the aperture can include attaching each spindle to a frame and installing the frame within the aperture.

Some aspects can include attaching, to the door, trim around the frame. The trim can prevent the frame from leaving the aperture.

In some aspects, each spindle is attached to the frame using one or more removable attachment devices. The trim can be attached to the door using removable attachment devices. Each removable attachment device can be a screw. In some aspects, the frame is attached to the door using one or more removable attachment devices.

Particular embodiments of the subject matter described in this specification can be implemented so as to realize one or more of the following advantages. Child safety doors described herein include openings through which parents (and others) can interact with, talk to, and view children while preventing injuries that result from the children attempting to (or succeeding at) climbing over or thorough a baby gate. For example, by having a door that substantially fills the doorway (e.g., with enough spacing between the door and doorway such that the door can swing open and closed but not enough for a child to pass), children are not motivated to attempt to climb over the door. An opening in the door with rods (e.g., spindles) prevents children from climbing through the opening while also allowing the parents to interact with the children. The structure of the door, location and size of the opening in the door, and the arrangement of the rods within the opening all combine to provide a way to prevent children from accessing areas of a house (or injuring themselves trying) while maximizing the ability of parents to interact with, view, and talk to children on the other side of the door. For example, configuring the door so that the opening is in a top half (or above the handle) of the full door reduces the likelihood that the child is able to reach through an open the door.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are illustrations of an example child safety door.

FIG. 2 is an illustration of another example child safety door.

FIG. 3 is an illustration of another example child safety door.

FIG. 4 is an illustration of another example child safety door.

FIG. 5 is a flow chart of an example process for using a child safety door to protect a child.

FIG. 6 is a flow chart of an example process for forming a child safety door.

Like reference numbers and designations in the various drawings indicate like elements.

### DETAILED DESCRIPTION

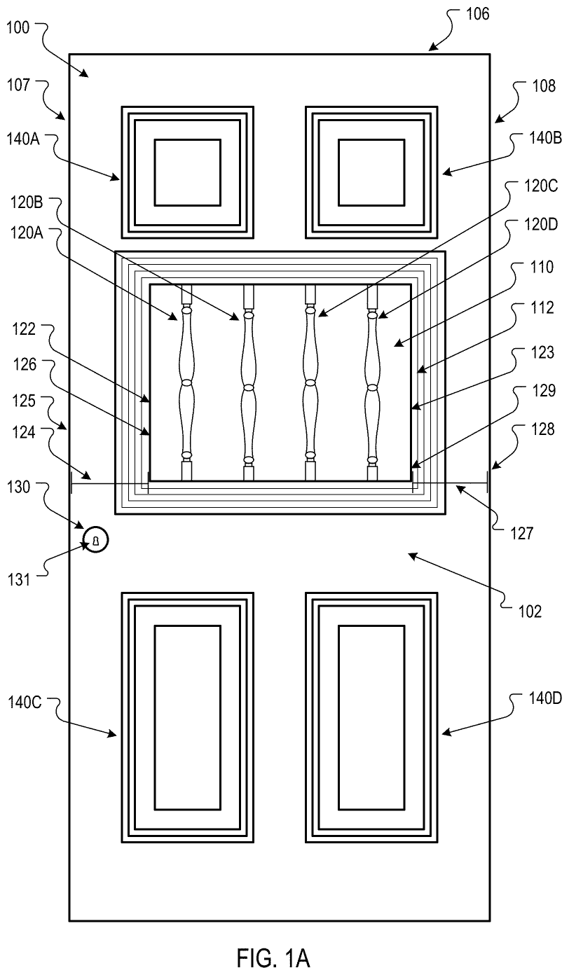

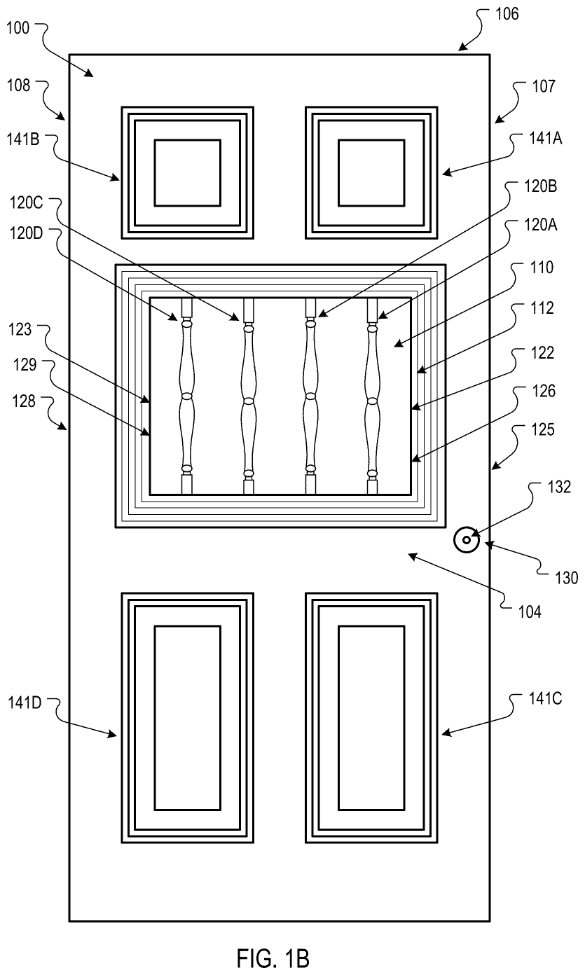

FIGS. 1A and 1B are illustrations of an example child safety door 100. The child safety door 100 includes a first side 102 (visible in FIG. 1A) and a second side 104 (visible in FIG. 1B) opposite the first side 102. Unlike a typical baby gate, the child safety door 100 can be sized to substantially fill a doorway. For example, the child safety door 100 can be sized such that, when the door 100 is installed in a doorway (e.g., an interior doorway), the space between each side of the door 100 and a corresponding side of the doorway is too small for a child to fit (e.g., less than two inches between the side of the door and the corresponding side of the doorway) when the door is closed. In some implementations, each side of the door 100 will be in contact with, or almost in contact with (e.g., within one or two millimeters of) the corresponding side of the doorway when the door 100 is closed.

In some implementations, the child safety door 100 can have a height of about 80 inches (e.g., between 78-82 inches) for common interior doorways (e.g., bedroom doorways of houses). However, the height of the child safety door 100 can be adapted to smaller and larger doorways such that the child safety door 100 fits in the doorway with enough space to swing open and closed but not enough room for a child to fit through (e.g., over, under, or to a lateral side) when the child safety door 100 is closed. For example, if the height of the doorway is 62 inches, the height of the child safety door can be 61.5 inches leaving about one quarter of an inch between the bottom of the child safety door 100 (not shown) and the floor and about one quarter of an inch between the top 106 of the child safety door 100 and the top of the doorway opening. In some implementations, the top 106 of the door 100 will be in contact with, or almost in contact with, (e.g., within one or more millimeters of), the top of the doorway opening when the door 100 is closed. Similarly, the bottom of the door 100 can be in contact with (or almost in contact with) the floor when the door 100 is closed.

Interior doorways typically have a width between about 24 inches and about 36 inches. Similar to the height, the width of the child safety door 110 can be adapted to doorways with various widths such that the child safety door 110 fits in the doorway with enough space swing open and closed but not enough room for a child to fit through (e.g., either side) when the child safety door 100 is closed. For example, if the width of the doorway is 33 inches, the child safety door 100 can be about 32.5 inches wide leaving about one quarter of an inch between each side of the door and the corresponding side of the doorway when the child safety door 100 is closed. As mentioned above, the sides of the door 100 can be in contact with (or almost in contact with) the sides of the doorway when the door 100 is closed.

The child safety door 100 can be installed in a doorway using hinges. The hinges can be attached between one side of the child safety door 100 and a doorjamb of a corresponding side of the doorway. For example, the hinges can be installed between the side 107 of the door 100 and a corresponding doorjamb of a doorway or between the side 108 and a corresponding doorjamb of the doorway. The hinges enable the door 100 to swing open and closed. The door can also be installed using other appropriate door installation mechanisms, e.g., using a sliding door mechanism.

The child safety door 100 includes an opening 110 that is defined in and extends through the child safety door 100 from the first side 102 to the second side 104. At least a portion of the opening 110 can be unfilled allowing air to flow through the opening 110 and thus, in and out of the room for which the child safety door 100 is installed. By having this opening 110, parents and others can interact with, talk to, listen to, and view a child in the room from outside the room. This also allows the child to view others and interact with others outside the room. Meanwhile, the portion of the safety door that is below the opening 110 can be solid.

The bottom of the opening 110 can be located within the safety door at a selected height from the bottom of the child safety door 100, which can either be pre-specified for all child safety door models, or can be selected based on various factors, as discussed in more detail below.

In the illustrated example, the opening 110 is positioned in the top half of the child safety door 100 (i.e., the bottom of the opening is located in the top half of the child safety door 100). The opening 110 can be positioned at a height measured from the bottom of the door 100 so that parents can easily look into the room, e.g., as they are passing the room from the other side of the door 100. This allows parents to check on children without opening the door 100 and potentially waking a sleeping child. Positioning the opening 110 in the top half of the door 100 can also prevent children from trying to detach spindles 120A-120D (described below) from the door 100. In some implementations, the bottom of the opening 110 is at least 36 inches above the bottom of the door 100. For a door 100 that has a height of about 80 inches, the bottom of the opening 110 can be about 40 inches (e.g., 38-42 inches) from the bottom of the door 100.

In some implementations, the location of the bottom of the opening 110 can be selected based on one or more factors. For example, the bottom of the opening could be located at a lower level in situations where the child safety door 100 is being used for younger children (e.g., shorter children or children that don't yet walk), and at a higher level in situations where the child safety door is being used for older children (e.g., taller children or children that walk).

The size of the opening 110 can vary based on the size of the child safety door 100. In general, the larger the child safety door 100, the larger the opening 110 can be to maximize the cohesiveness between the rooms on both sides of the child safety door 100 and to maximize the ability for a person on one side of the door 100 to see inside the room on the other side of the door 100 when the door 100 is closed. For a door 100 that has a height of about 80 inches (e.g., 78-82 inches) and a width of about 32 inches (e.g., 28-34 inches), the opening 110 can be about 23 inches (e.g., 21-25 inches) tall and about 21 inches (e.g., 19-23 inches) wide.

The width of the opening 110 can be selected to ensure that the portions of the door 100 between the opening 110 and the end of the side of the door is wide enough to provide sufficient support such that a child cannot break that portion of the door 100. For example, the portion 124 of the door 100 can have at least a minimum width (e.g., at least three inches) between the end 125 of the door 100 and the side 126 of the opening 110. Similarly, the portion 127 of the door 100 can have a minimum width (e.g., at least three inches) between the end 128 of the door 100 and the side 129 of the opening 110. If the width was small (e.g., less than one half inch) on a wooden door, older children may be able to break that portion of the door 100.

The height of the opening 110 can also be selected ensure that the portion of the door 110 between the top of the opening 110 and the top of the door 100 is tall enough to provide sufficient support such that a child cannot break that portion of the door 100. For example, the portion of the door 100 between the top of the opening 110 and the top of the door 100 can be at least a minimum height (e.g., at least three inches).

Although the example opening 110 has a rectangular shape, the opening 110 could have other shapes. For example, the opening 110 could have a round or oval shape.

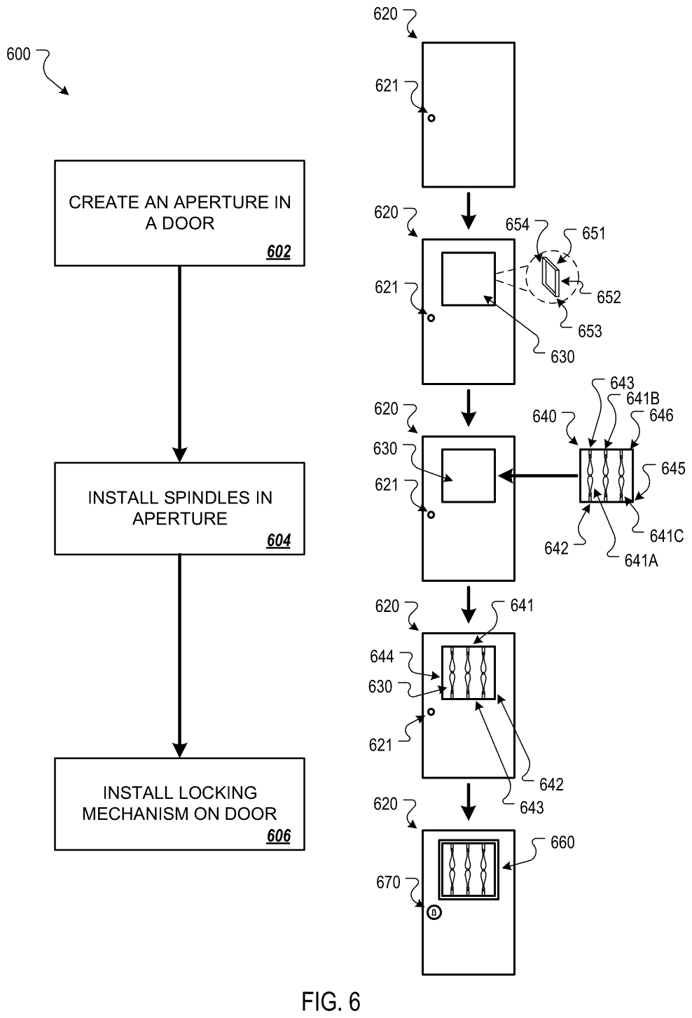

The child safety door 100 includes spindles 120A-120D arranged in the opening 110. For example, the opening 110 can be cut into the door 100 (or otherwise made) and a frame that includes the spindles 120A-120D can be installed within the opening 110. The frame can be attached to each interior wall of the opening 110 in way that ensures that children cannot detach the frame 112 (and the spindles 120A-120D) from the door 110. For example, the frame can be nailed to, screwed to, or glued to the walls of the opening 110. An example process for creating a child safety door, including attaching a frame with spindles to the door is illustrated in FIG. 6 and described below.

The child safety door 100 also includes trim 112 around the opening 110. The trim 112 can secure the frame and spindles 120A-120D in the opening. For example, the trim 112 can be secured to the door 100 using glue, nails, screws, or other appropriate attachment devices or attachment mechanisms. The trim 112 can be attached on all four sides of the opening 110 on both sides 102 and 104 of the door 100. The trim 112 can block the frame and spindles from being pushed through either side of the opening. For example, the trim 112 can cover all four sides of the frame that holds the spindles 120A-120D.

In this example, the child safety door 100 has four spindles 120A-120D, but the child safety door 100 could include fewer than four or more than four spindles in other examples based on the size of the opening 110. In some implementations, other types of rods, poles, or shafts, can be used in place of the spindles 120A-120D, such as blusters. Other objects can also be used in place of the spindles, e.g., a wooden lattice. The spindles 120A-120D can be made of wood, metal, or other material. In some implementations, the spindles 120A-120D are made of the same material as the door 110 and the frame 112, e.g., all three being made of wood. For added strength (e.g., to prevent breakage or removal), the spindles 120A-120D can be made of pressure treated wood, metal, or another appropriate material.

The spindles 120A-120D prevent children from climbing through the opening without unduly blocking the ability for people to see through the opening. The number of spindles can be selected based on the size of the opening 110 and/or the width of the spindles 120A-120D to provide a maximum distance between adjacent spindles 120A-120D. For example, the spindles 120A-120D can be spaced apart up to a maximum distance to prevent a child from fitting between adjacent spindles 120A-120D (or to prevent a child's head from fitting between adjacent spindles 120A-120D). In a particular example, adjacent spindles (e.g., spindles 120A and 120B) can be spaced apart no more than four or five inches. The end spindles 120A and 120D can also be spaced apart no more than four to five inches from their respective sides of the opening 110. For example, the spindle 120A can be up to four or five inches from the side 122 and the spindle 120D can be up to four or five inches from the side 123.

The combination of the size of the opening 110, the arrangement of the spindles 120A-120D, the frame 112, and the location of the opening 110 within the child safety door 100 provide structural features that protect children from being able to break portions of the door 110, break the spindles 120A-120D, or remove the spindles 120A-120 D, while also enabling parents and others maximum visibility into the room when the door 100 is closed.

The spindles 120A-120D and/or the frame 112 can include decorative features that make the child safety door 100 suitable for use inside of houses and other buildings. For example, the door 100 can include decorative panels 140A-140D and 141A-141D on both sides of the door 100 (or just one side). As described below, a child safety door can also include curtains, valances, drapes, blinds and/or other window treatment to further enhance the aesthetic aspects of the door 100 for use in houses and other buildings and provide privacy for children in the room while allowing access by parents if needed.

The child safety door 100 also includes a door knob 130. The door knob 130 is a locking door knob (e.g., a locking mechanism) that includes a key hole 131 on one side (side 104) and a locking component 132 on the other side. The locking component 132 can be a push button lock, a twist lock, a latch, another key hole (e.g., if the door knob is a double-keyed lock, or another type of locking component. In some implementations, the door knob 130 does not include a key hole. Instead, the door knob 130 can include a locking component on one side (e.g., the parent side) of the door 100 and a knob without a locking component on the other side (e.g., the child side) of the door 100. In this example, the child side of the door knob 130 can include a small hole through which an interior door emergency key or screw driver can be used to unlock the door 100 if needed. Other appropriate types of locking mechanisms can also be used in place of the door knob 130, such as a latch that rests in a groove on one side of the door 100 to lock the door 100 and prevent a child from unlocking the door 100 from the other side.

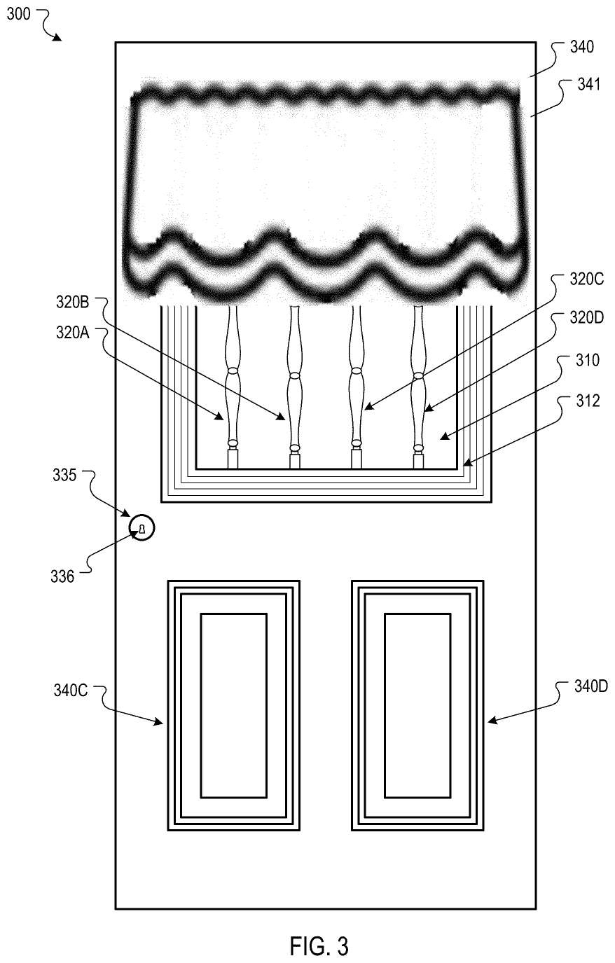

In some implementations, the door knob 130 is a double-keyed lock that, when locked, requires a key to unlock from either side of the door 100. For example, as illustrated in FIG. 3 and described below, the double-keyed lock can include a key hole on both sides. Using a double-keyed lock can prevent children from reaching through the opening 110 and unlocking the door 100. For example, if a single-keyed lock with a push button or twist lock is installed in the door 100 and a child can reach through the opening 110, the child may be able to reach the push button or twist lock and unlock the door 100. Using a double-keyed lock (e.g., a double-keyed deadbolt lock) prevents a child from unlocking the door 110 without the key even if the child can reach through the opening 110.

In some implementations, the spindles 120A-120D, its frame, and/or the trim 112 are removably attached (e.g., can be removed by a parent using a common tool) to the door using removable attachment devices or mechanisms. For example, as described below, the spindles can be attached to the frame using screws. In another example, the spindles can be spring loaded collapsible spindles that a person can shorten by pushing the ends toward each other and, when the spindle is in position, the person can allow the spring to extend the spindle into holes on either side of the frame.

The trim 112 can also be attached to the door 100 using screws. The screws for the trim 112 can be installed on the parent side of the door so that a child cannot remove the trim 112 with a screwdriver. In this way, a parent (or other person) can change the trim 112, the frame, and/or the spindles 120A-120D. For example, the parent can replace damaged or broken spindles or install a different style of spindles to give the door 100 a different appearance. In another example, frames with spindles can be interchangeable allowing for easy switching between styles or types of spindles.

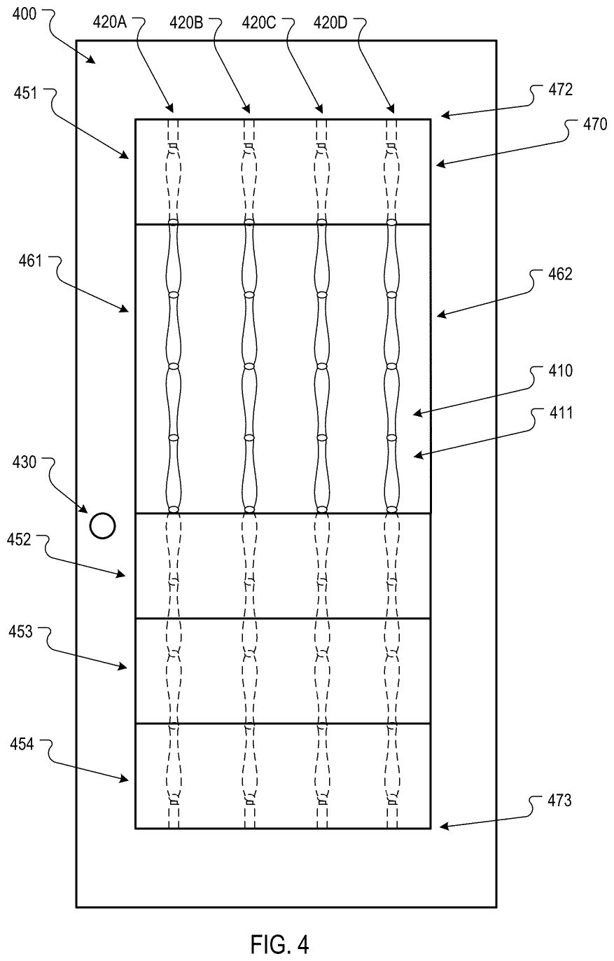

In some implementations, the location of the opening 110 and/or the spindles 120A-120D within the door 100 is adjustable. For example, a parent may want to raise the top of the opening as the child gets older, e.g., so that the child's head is not above the opening when the child is standing. The location of the opening 110 and the visible spindles 120A-120D can be adjustable using movable or removable panels in the door 110. For example, the spindles 120A-120D can be longer than what is visible in the opening 110. Panels on the door 100 can be used to cover the portions of the spindles 120A-120D where the parent does not want the opening to be. Panels where the opening 110 is desired can be removed (or moved up or down to a previous opening) to expose the spindles 120A-120D at the desired location in the door. An example of a child safety door with moveable panels is illustrated in FIG. 4 and described below.

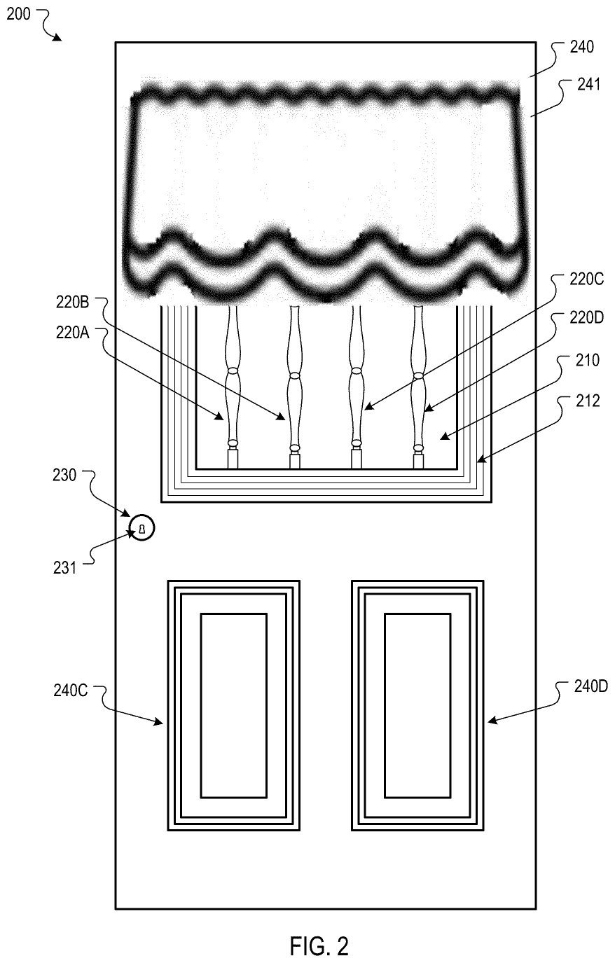

FIG. 2 is an illustration of another example child safety door 200. Like the child safety door 100 of FIG. 1, the child safety door 200 includes an opening 210, a frame 212 around the opening 210, spindles 220A-220D arranged in the opening 210, and a door knob 230 (e.g., a single-keyed or double-keyed locking door knob). The size and structure of the these parts of the door 200 can the same as, or similar to the corresponding parts of the door 100.

The child safety door 200 also include a valance 241 hanging on a rod 240 (behind the valance 241) that is attached to the door 200. The valance 241 can be decorative, e.g., to match a theme of the child's room. The door 200 can include a valance 241 on one or both sides of the door. The door 200 can include other window treatments in place of, or in addition to, the valance. For example, the door 200 can include a curtain that can extend to (or past) the bottom of the opening 210. The window treatments can allow for privacy in the room while also allowing a parent to check on the child.

The door 200 also includes decorative panels 240C and 240D on one or both sides of the door 200. The door 200 can also include decorative panels on the top half of the door 200 behind the valance (e.g., in the same location at the decorative panels 140A and 140B of the door 100 illustrated in FIG. 1.

FIG. 3 is an illustration of another example child safety door 300. Like the child safety doors 100 and 200 of FIGS. 1 and 2, the child safety door 300 includes an opening 310, a frame 312 around the opening 310, spindles 320A-320D arranged in the opening 310, and a bore hole (covered by a locking mechanism 335 installed in the bore hole). The door 300 also includes a valance 341 hanging on a rod 340 (behind the valance 341).

In this example, the locking mechanism 335 is a double-keyed lock that requires a key on both sides of the locking mechanism 335 (and thus both sides of the door 300). That is, the locking mechanism 335 has a key hole 336 that accepts a key on the side of the door 300 visible in FIG. 3 and another key hole on the other side of the door 300 that is not visible in FIG. 3. The locking mechanism 335 can be a double-keyed deadbolt lock in some implementations. As described above, using a double-keyed lock can prevent a child from reaching through the opening 310 and unlocking the locking mechanism 335.

The door 300 also includes decorative panels 340A and 340B on one or both sides of the door 300. The door 300 can also include decorative panels on the top half of the door 300 behind the valance (e.g., in the same location at the decorative panels 140A and 140B of the door 100 illustrated in FIG. 1).

FIG. 4 is an illustration of another example child safety door 400. The example child safety door 400 includes four spindles 420A-420-D (although the door 400 can include other appropriate numbers of spindles) and an adjustable open portion 411. In this example, the spindles 420A-420D extend from the bottom half of the door 400 into the top half of the door 400. Each spindle 420A-420D can be attached to a top portion 472 of a frame 470 positioned in an aperture 410 and a bottom portion 473 of the frame 470. Each side of the frame 470 is adjacent to a corresponding side of the aperture 410 in the door 400.

The child safety door 400 also includes door panels 451-454 that are used to adjust the location and/or size of the open portion 411 of the aperture 410 that is actually open between the two sides (e.g., child and parent sides) of the door 400. For example, an aperture 410 can be cut into the door 400 from the location of the bottom of the frame 473 to the location of the top of the frame 472. The door panels 451-454 can be moved around in the aperture 410 to close (e.g., block the view) through portions of the aperture 410, thereby adjusting the location of the open portion 411 of the aperture that is actually open between the two sides of the door 400.

The portions of the spindles 420A-420D shown in dashed lines are hidden behind the door panels 451-454. The solid portions of the spindles 420A-420D are viewable in the open portion 411. For example, the door panels 451-454 can be made of wood that matches the door 400 or another opaque material. The door panels 451-454 can be moved up and down within the aperture 410 to adjust the location of the open portion 411. For example, if the door panel 451 is moved down such that the bottom of the door panel 451 is adjacent to the top of the door panel 452, the open portion 411 would be higher than that shown in FIG. 4. That is, the open portion 411 would extend from the top of the door panel 451 to the top portion 472 of the frame 470.

The door panels 451-454 can be removably attached to vertical attachment members 461 and 462. For example, each door panel 451-454 can include a tab (or other appropriate type of protrusion) on either lateral side that can be inserted into, and removed from, corresponding slots (or other appropriate receiving members) in the attachment members 461 and 462. The slots can be located along the length of each attachment member 461 and 462 to allow for customizable locations for the open portion 411 of the aperture. This allows parents to adjust the location of the open portion, e.g., as the child gets older and taller or for use with other children.

Door panels 451-454 and their attachment members 461 and 461 can be located on one or both sides of the door 400. For example, the same types of door panels 451-454 and attachment members 461 and 462 can be installed on both sides of the door 400. In another example, at least a portion of the door panels 451-451 can be thick enough that the back side of the door panels 451-454 are flush with the surface of the other side of the door 400.

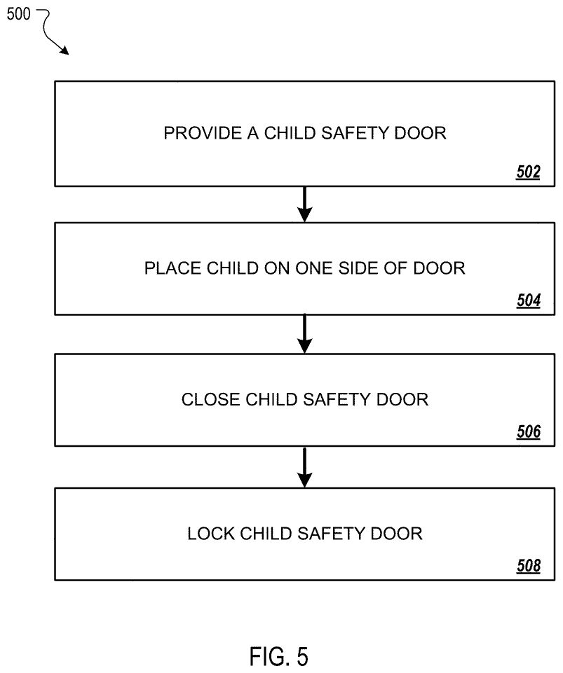

FIG. 5 is a flow chart of an example process 500 for using a child safety door to protect a child. The example process 500 can be performed using any of the doors 100, 200, 300, or 400 illustrated in FIGS. 1-4 and described above.

A child safety door is provided (502). For example, a person can install the child safety door using hinges between one side of the door and a doorjamb on a corresponding side of a doorway or other opening. The child safety door can be installed such that it swings open and closed using the hinges. The child safety door can be installed in a doorway or other opening to prevent a child from entering or leaving a particular area. For example, the child safety door can be installed in a doorway of the child's bedroom. In another example, the child safety door can be installed at the top or bottom of a staircase, e.g., a staircase to a basement or between two levels of a house. In yet another example, the child safety door can be installed in an opening between a portion of a house and a swimming pool to protect the child from entering the pool unattended.

A child is placed on one side of the door (504). For example, a parent or other caretaker can carry or walk with a child into a room on one side of the door. If the child safety door is installed in the doorway of the child's bedroom, the child can be carried or walked into the bedroom.

The child safety door is closed (506). For example, the parent, caretaker, or child can close the door by swinging the door along the hinges until the door is in the closed position. If the door has a door knob, a latch of the door knob can be secured in a corresponding hole of the doorjamb of the doorway when the door is in the closed position.

With the child safety door closed, the door is locked (508). This prevents a person from opening the door from either side of the door without placing the locking mechanism in an unlocked position. If the child safety door includes a double-keyed lock (e.g., a double-keyed deadbolt or double-keyed door knob, a person can lock the door using a key on either side of the door. For example, the parent or caretaker can lock the door from the side opposite the room in which the child is located. As described above, the double-key lock prevents the child from unlocking the door without a key.

FIG. 6 is a flow chart of an example process 600 for creating a child safety door 620. The door 620 includes a bore hole 621 for installing a locking mechanism. The door 620 can also include decorative panels on one or both sides. The door 620 can be made of wood or another appropriate material. The door 620 can be hollow or solid.

An aperture (e.g., opening) is created in the door (602). The aperture 630 can be the same as or similar to the openings 110, 210, and 310 of the example doors illustrated in FIGS. 1-3. The aperture 630 can be cut into the door 620 using a saw or other appropriate cutting device. In this example, the aperture 630 has a rectangular (e.g., square) shape. In other examples, the aperture 630 can have a different shape, e.g., a round, oval, or other appropriate shape.

Spindles 641A-641C are installed in the aperture (604). The spindles 641A-641C can be attached to a frame 640 that is sized to fit tightly in the aperture 630. For example, if the aperture 630 has a rectangular shape, the frame 640 can also have a rectangular shape with an outer perimeter that matches (or is slightly smaller than) the inner perimeter of the aperture. The frame 640 can be made of wood (e.g., pressure treated wood) or another appropriate material. For example, the frame 640 can be formed using four pieces of wood that are attached together using nails, screws, or other appropriate attachment devices or attachment mechanisms.

The spindles 641A-641C can be sized to fit snuggly in the frame 640 and extend from one side of the frame 640 to an opposite side of the frame 640. For example, the spindles 641A-641C can be fabricated (or cut from pre-fabricated spindles) to a length that extends from a side 645 of the frame 640 that will be positioned adjacent to (e.g., attached to) the bottom of the aperture 630 to a side 646 of the frame 640 that will be positioned adjacent to (e.g., attached to) the top of the aperture 630.

Each spindle 641A-641C can be attached to both sides 645 and 646 of the frame 640 using glue, liquid nails, nails, screws, or other appropriate attachment devices or attachment mechanisms. In some implementations, each spindle 641A-641C is attached to both sides 645 and 646 of the frame 640 using a combination of liquid nails and screws. In some implementations, each spindle is attached to both sides of the frame using only screws or another appropriate type of removable attachment device that allows for ease of removal of the spindles from the frame when the frame is detached from the door. This allows spindles to easily be replaced when damaged, broken, or to change the appearance of the door. For example, a screw can be installed through the frame 640 at point 642 and into the spindle 641A. Similarly, a screw can be installed through the frame at point 643 and into the spindle 641A. Each other spindle 641B and 641C can be attached to the frame 640 using screws in similar locations for those spindles.

The frame 640 is installed in the aperture 630 by fitting the frame 640 within the aperture 630 such that the spindles are in the appropriate direction (e.g., extend in a direction from the bottom of the aperture 630 towards the top of the aperture 630). In some implementations, one or more attachment devices or attachment mechanisms can be used to secure the frame 640 to the door 620. For example, wood glue or liquid nails could be applied to the outside of the frame 640 that will be adjacent to the sides of the aperture 630 prior to installing the frame 640. In another example, the frame 640 may be sized such that the frame 640 extends out from the aperture 630 on both sides of the aperture 630. In this example, wood glue or liquid nails can be applied around the perimeter of each side 641-644 of the frame 640 where the frame 640 contacts the edge of the door 620 around the aperture 630.

In some implementations, the frame 640 is removably attached to the door 620 using one or more attachment devices of mechanisms. For example, if the door 620 is a solid door, the door 620 will include walls 651-654 that define the aperture 630. A door with a square-shaped aperture 630 will include four walls 651-654, a bottom wall 653 that defines the bottom of the aperture 630, a top wall 651 that defines the top of the aperture 630 and walls 652 and 654 on either lateral side of the aperture 630. The frame 640 can be removably attached to the door 620 by inserting a screw (or other appropriate removable attachment device) through each side of the frame 640 into the corresponding wall of the door 620 within the aperture 640. In this way, if a parent wants to change frame 640 or spindles 641A-641D, the parent can remove the screws and attach a different frame or replace spindles in the frame 640 and reattach the frame 640 to the door 620 by reinserting the screws.

If the door is hollow, attachment devices that can hold a screw in place can be attached to the hollow walls of the door 640 that define the aperture 630. For example, a metal plate (or other appropriate material plate) can be attached to each wall by attaching a side of the plate to one side of the door 620 and attaching the other side of the plate to the other side of the door 620. After the frame 640 is placed into the aperture, a screw can be inserted through each side of the frame 640 into the metal plate on the corresponding side of the aperture 630.

In some implementations, trim 660 is installed around the frame 640 and attached to the portion of the door 620 along the perimeter of the aperture 630. The trim 660 can be installed on both sides of the door (e.g., the child side and the parent side). As discussed above, the trim 660 can help hold the frame 640 and its spindles 641A-541D in place in the aperture 630. The trim 660 can be attached to the frame 640 and/or door 620 using wood glue, liquid nails, pin nails, screws, or other appropriate attachment devices or attachment mechanisms. In some implementations, the trim 660 is attached to the door 620 using screws or another easily removable attachment device to that the trim 660 can easily be removed to replace or repair the frame 640 or spindles 641A-641D. In some implementations, the trim 660 can be made of wood, metal or another appropriate material that is strong enough to prevent the frame 640 from leaving the aperture 630 (e.g., being pushed out by a child) unless the trim 660 is removed.

A locking mechanism 670 is installed on the door (606). As described above, the locking mechanism can include a single-keyed door knob, a double-keyed door knob, a double-keyed deadbolt, a door knob with a locking component on one side and a small hole on the other side, or another appropriate locking mechanism. Door knob and deadbolt locking mechanisms can be installed in the bore hole 621 in the door 620.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, particular embodiments of the subject matter have been described. Other embodiments are within the scope of the following claims.

What is claimed is:

1. A child safety door, comprising:
a door with a first side and a second side opposite the first side, the door having a height of at least sixty inches and a width of at least twenty-four inches;
an opening that extends through the door from the first side to the second side, the opening being located at a top half of the door when the door is installed in a doorway, the opening having a height of at least ten inches and a width of at least ten inches;
a plurality of spindles that each extend from a bottom of the opening to a top of the opening; and
a locking mechanism that, when locked, prevents a person from opening the door from either side of the door without placing the locking mechanism in an unlocked position.

2. The child safety door of claim 1, wherein the door has a height between seventy-eight and eighty-two inches and a width between twenty-two and thirty-eight inches.

3. The child safety door of claim 2, wherein the opening has a height between twenty and twenty-four inches and a width between twenty and twenty-four inches.

4. The child safety door of claim 2, wherein the bottom of the opening is between thirty and fifty inches above a bottom of the door.

5. The child safety door of claim 1, wherein each spindle is spaced apart from each adjacent spindle by no more than four inches.

6. The child safety door of claim 1, wherein the locking mechanism comprises a double-keyed lock.

7. The child safety door of claim 6, wherein the double-keyed lock comprises a double-keyed deadbolt.

8. A method for using a child safety door to protect a child, the method comprising:
providing a child safety door in a doorway, the child safety door comprising:
a door with a first side and a second side opposite the first side, the door having a height between seventy-eight and eighty-two inches and a width between twenty-two and thirty-eight inches;
an opening that extends through the door from the first side to the second side, the opening being located such that a bottom of the opening is at least thirty-six inches above a bottom of the door, the opening having a height of at least twenty inches and a width of at least twenty inches;
a plurality of spindles that each extend from the bottom of the opening to a top of the opening; and
a locking mechanism that, when locked, prevents a person from opening the door from either side of the door without a key;
closing the child safety door such that the child safety door blocks children from going through the doorway; and
locking the locking mechanism of the child safety door while the child safety door is closed.

9. The method of claim 8, wherein providing the child safety door comprises installing the child safety door in the doorway.

10. The method of claim 8, wherein the opening has a height between twenty and twenty-four inches and a width between twenty and twenty-four inches.

11. The method of claim 8, wherein the bottom of the opening is between thirty and fifty inches above a bottom of the door.

12. The method of claim 8, wherein each spindle is spaced apart from each adjacent spindle by no more than four inches.

13. The method of claim 8, wherein the locking mechanism comprises a double-keyed lock.

14. A method of forming a child safety door, comprising:
creating, within a door having a first side and a second side opposite the first side, an aperture that extends through the door from the first side to the second side, wherein the aperture is created in a top half of the door, having a height of at least ten inches, and a width of at least ten inches;
installing, within the aperture, a plurality of spindles that each extend between a bottom of the aperture and a top of the aperture; and
installing a locking mechanism that prevents the door from being opened from either side of the door without placing the locking mechanism in an unlocked position.

15. The method of claim 14, wherein installing the plurality of spindles within the aperture comprises:
attaching each spindle to a frame; and
installing the frame within the aperture.

16. The method of claim 15, further comprising attaching, to the door, trim around the frame.

17. The method of claim 16, wherein the trim prevents the frame from leaving the aperture.

18. The method of claim 16, wherein:
each spindle is attached to the frame using one or more removable attachment devices; and
the trim is attached to the door using a plurality of removable attachment devices.

19. The method of claim 18, wherein each removable attachment device is a screw.

20. The method of claim 16, wherein the frame is attached to the door using one or more removable attachment devices.
